(19) United States
(12) Patent Application Publication
(10) Pub. No.: US 2023/0273964 A1
(43) Pub. Date: Aug. 31, 2023

(54) APPARATUS AND METHOD FOR EVALUATING SEARCH ENGINE PERFORMANCE, AND DASHBOARD

(71) Applicants: SAMSUNG SDS CO., LTD., Seoul (KR); Korea Advanced Institute of Science and Technology, Daejeon (KR)

(72) Inventors: Jaehoon Lee, Seoul (KR); Juho Kim, Daejeon (KR); Kabdo Choi, Daejeon (KR); Mehmet Hamza Erol, Daejeon (KR); Hyunwoo Kim, Daejeon (KR); Meng Xia, Daejeon (KR)

(21) Appl. No.: 18/099,322

(22) Filed: Jan. 20, 2023

(30) Foreign Application Priority Data
Feb. 28, 2022 (KR) 10-2022-0026112
Sep. 7, 2022 (KR) 10-2022-0113703

(51) Int. Cl. G06F 16/9535; G06F 16/9538; G06F 16/906

(52) U.S. Cl. CPC G06F 16/9535; G06F 16/9538; G06F 16/906

(57) ABSTRACT

An apparatus for evaluating search engine performance includes a search intent retriever configured to generate and output a similar search intention cluster using a search performance metric value for each search session and a result of session clustering for each search intention, a behavior pattern retriever configured to generate and output a similar behavior pattern cluster and a behavior pattern for each cluster through clustering of a search session indicating a similar behavior pattern in the similar search intention cluster using a result of session clustering for each user behavior pattern, a first search session retriever configured to generate and output a behavior of a user for each search session, and a second search session retriever configured to generate and output a specific behavior of the user for a specific search session selected by the user.

### CROSS-REFERENCE TO RELATED APPLICATION(S) AND CLAIM OF PRIORITY

This application claims the benefit under 35 USC § 119 of Korean Patent Application Nos. 10-2022-0026112 filed on Feb. 28, 2022 and 10-2022-113703 filed on Sep. 7, 2022 in the Korean Intellectual Property Office, the disclosure of which is incorporated herein by reference in its entirety.

### BACKGROUND

### 1. Field

Example embodiments relate to an apparatus and method for evaluating search engine performance, and a dashboard.

### 2. Description of Related Art

Various methods are used to evaluate performance of a search engine. In order to evaluate relevance of search results presented by the search engine in response to a specific search query, there is provided a method of performing an evaluation by comparing a search result presented by the search engine with an ideal search result for each predefined query using various metrics.

In addition, there is provided a method for evaluating, based on a record of an actual search engine user using a search engine, how the actual user uses a search result using a ratio of a search session in which a user undertakes a specific behavior.

The above-described method for evaluating a search engine has been widely used to generally evaluate the performance of the search engine.

However, even when it is discovered that there is a problem in the performance of the search engine using a metric according to the related art, it is necessary to specifically determine a search intent of a user in a situation in which the user is not satisfied with a search result of the search engine, so as to improve the search engine.

### SUMMARY

An aspect provides an apparatus and method for evaluating search engine performance, and a dashboard for allowing the search engine performance to be evaluated from a point of view of a user.

According to an aspect, there is provided an apparatus for evaluating search engine performance, the apparatus including a search intent retriever configured to generate and output a similar search intention cluster using a search performance metric value for each search session and a result of session clustering for each search intention, a behavior pattern retriever configured to generate and output a similar behavior pattern cluster and a behavior pattern for each cluster through clustering of a search session indicating a similar behavior pattern in the similar search intention cluster using a result of session clustering for each user behavior pattern, a first search session retriever configured to generate and output a behavior of a user for each search session, and a second search session retriever configured to generate and output a specific behavior of the user for a specific search session selected by the user.

The search intention retriever may be configured to output a search performance metric value for each cluster, together with the similar search intention cluster.

When the similar search intention cluster is output, the search intent retriever may be configured to output a representative query for each cluster in the form of a word cloud.

The search intention retriever may be configured to add and output a distinguishing mark to an outlier cluster collecting a search session failing to classify a search intention.

When the similar search intention cluster is output, the search intention retriever may be configured to output a size of the cluster in proportion to the number of search sessions included in each cluster.

The search intention retriever may be configured to calculate an average metric value for each cluster for a specific search performance metric selected by the user among a plurality of search performance metrics of a search engine, and to output, based on a calculation result, each cluster in a distinguishable color.

When the similar search intention cluster is output, the search intention retriever may be configured to generate and output distribution of a search performance metric value for each cluster.

The search intention retriever may be configured to change a distinguishing mark status for each cluster through adjustment of a threshold value that is a reference of distribution of the search performance metric value for each cluster.

The search intention retriever may be configured to output another list of keywords associated with a cluster selected by the user and another search performance metric value of the cluster in a pop-up form.

The behavior pattern retriever may be configured to generate and output a representative behavior pattern for each similar behavior pattern cluster, and to classify and output a specific user behavior for each representative behavior pattern using a distinguishable icon and color.

When a specific similar behavior pattern cluster is selected by the user, the first search session retriever may be configured to output a list of search sessions included in the selected similar behavior pattern cluster, and to output query information and a user behavior matched to each search session together.

When the list of search sessions is output, the first search session retriever may be configured to adjust sorting of the list of search sessions according to the search performance metric value for each search session.

According to another aspect, there is provided a method for evaluating search engine performance, the method including generating and outputting a similar search intention cluster using a search performance metric value for each search session and a result of session clustering for each search intention, generating and outputting a similar behavior pattern cluster and a behavior pattern for each cluster through clustering of a search session indicating a similar behavior pattern in the similar search intention cluster using a result of session clustering for each user behavior pattern, generating and outputting a behavior of a user for each search session, and generating and outputting a specific behavior of the user for a specific search session selected by the user.

The generating and outputting the similar search intention cluster may include outputting a search performance metric value for each cluster, together with the similar search intention cluster.

The generating and outputting the similar search intention cluster may include outputting a representative query for each cluster in the form of a word cloud.

The generating and outputting the similar search intention cluster may include adding and outputting a distinguishing mark to an outlier cluster collecting a search session failing to classify a search intention.

The generating and outputting the similar search intention cluster may include calculating an average metric value for each cluster for a specific search performance metric selected by the user among a plurality of search performance metrics of a search engine, and outputting, based on a calculation result, each cluster in a distinguishable color.

The generating and outputting the similar search intention cluster may include generating and outputting distribution of a search performance metric value for each cluster, and changing a distinguishing mark status for each cluster through adjustment of a threshold value that is a reference of distribution of the search performance metric value for each cluster.

The generating and outputting the similar behavior pattern cluster and the behavior pattern for each cluster may include classifying and outputting a specific user behavior for each representative behavior pattern using a distinguishable icon and color.

The generating and outputting the behavior of the user for each search session may include outputting a list of search sessions included in the selected similar behavior pattern cluster, when a specific similar behavior pattern cluster is selected by the user, and outputting query information and a user behavior matched to each search session together.

According to another aspect, there is provided a dashboard including a search intent retrieval interface configured to output a similar search intention cluster using a search performance metric value for each search session and a result of session clustering for each search intent, a behavior pattern retrieval interface configured to output a similar behavior pattern cluster and a behavior pattern for each cluster through clustering of a search session indicating a similar behavior pattern in the similar search intention cluster using a result of session clustering for each user behavior pattern, a first search session retrieval interface configured to output a behavior of a user for each search session, and a second search session retrieval interface configured to output a specific behavior of the user for a specific search session selected by the user.

According to example embodiments, it is possible to provide a search engine performance evaluation method for analysis of a search engine usage log usable for an improvement in a search engine by discovering a search session that need to be improved based on user satisfaction with the search engine.

In addition, the understanding of improvement points from a point of view of the user of the search engine may be improved, and thus the improvement points of the search engine may be rapidly and easily discovered, thereby improving search engine performance.

In addition, a multistep workflow for retrieving a search engine usage history may be used to support various types of sequential data analysis including a user log of the search engine.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 is a block diagram illustrating an apparatus for evaluating search engine performance according to an example embodiment;

FIGS. 2 to 8 are exemplary diagrams illustrating a method for evaluating search engine performance according to an example embodiment;

FIG. 9 is a flowchart illustrating a method for evaluating search engine performance according to an example embodiment;

FIG. 10 is a block diagram illustrating a dashboard according to another example embodiment;

FIG. 11 is a block diagram illustrating an apparatus for evaluating search engine performance according to another example embodiment;

FIGS. 12 to 19 are exemplary diagrams illustrating a method for evaluating search engine performance according to another example embodiment;

FIG. 20 is a block diagram illustrating a dashboard according to another example embodiment; and

FIG. 21 is a block diagram illustrating a computing environment including a computing device according to an example embodiment.

### DETAILED DESCRIPTION

Hereinafter, specific example embodiments of the present disclosure will be described with reference to the accompanying drawings. The following detailed description is provided to aid in a comprehensive understanding of a method, a device and/or a system described in the present specification. However, the detailed description is for illustrative purposes only, and the present disclosure is not limited thereto.

In describing the example embodiments of the present disclosure, when it is determined that a detailed description of a known technology related to the present disclosure may unnecessarily obscure the gist of the present disclosure, the detailed description thereof will be omitted. In addition, terms to be described later are terms defined in consideration of functions in the present disclosure, which may vary depending on intention or custom of a user or operator. Therefore, the definition of these terms should be made based on the contents throughout the present specification. The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

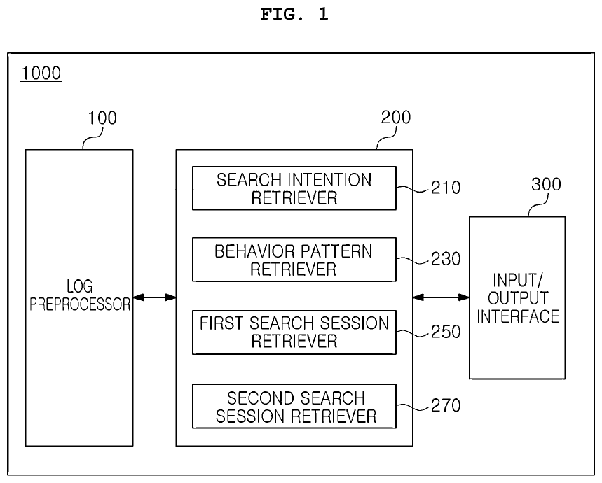

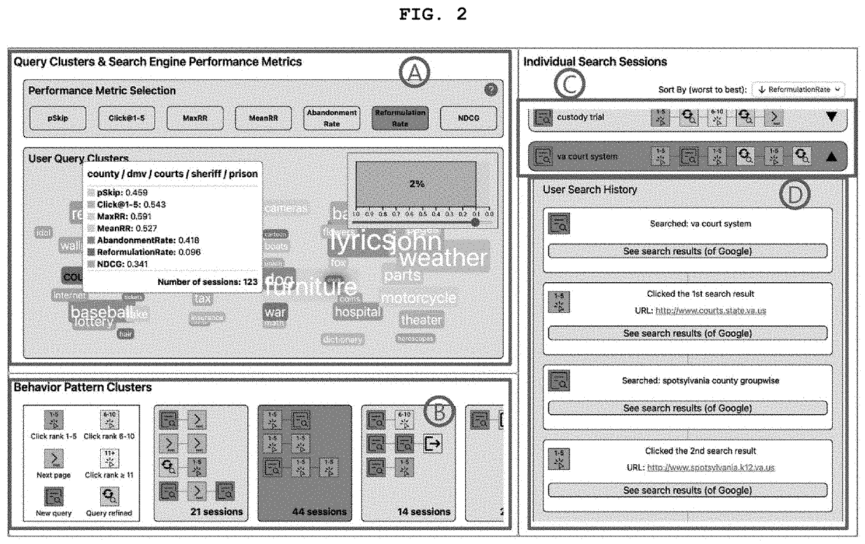

FIG. 1 is a block diagram illustrating an apparatus for evaluating search engine performance according to an example embodiment. Hereinafter, a description will be given with reference to FIGS. 2 to 8, which are exemplary diagrams illustrating a method for evaluating search engine performance according to an example embodiment.

Referring to FIG. 1, a search engine performance evaluation apparatus 1000 may include a log analyzer 200 and an input/output interface 300. In addition, the search engine performance evaluation apparatus 1000 may further include a log preprocessor 100.

The log preprocessor 100 may perform preprocessing on a search engine usage log, such that a user may perform searching on a search engine to find desired information and may analyze a user behavior of the search engine in units of search sessions deviating from the search engine.

The log preprocessor 100 may divide a user behavior record of the search engine into logs in units of search sessions, subdivide a user behavior in a search session through query reformulation behavior subdivision and click behavior subdivision according to ranking, and calculate a search performance metric value for each session. Thus, the log preprocessor 100 may identify relationships between multiple queries in the search session, type information of a click in the search session, and the like to apply the identified relationships, the type information, and the like to a user behavior pattern.

The above-described division of the search session may refer to considering that a search session is terminated when 30 minutes have elapsed since a user performed a last behavior on a search engine usage record of each search engine user, and dividing the session. In addition, subdivision of a user behavior in the search session may be subdividing a user behavior into the following items. In this case, items for classifying the user behavior may include NewQuery, RefinedQuery, NextPage, and Click1-5/Click6-10/Click11+. The NewQuery may refer to submitting a new query rather than modifying an existing query according to manipulation of the user. The RefinedQuery may refer to resubmitting a query by modifying an existing query according to manipulation of the user. For example, when a Levenshtein distance between the existing query and the new query is 3 or less, and stop words are removed and lemmatized, and then a Jaccard similarity between the existing and new queries is 0.7 or more, it may be determined that the existing query is modified. NextPage may refer to moving to a next page of a search result according to manipulation of the user, and Click1-5/Click6-10/Click11+, clicking a search result according to manipulation of the user, may refer to three events classified according to a rank of the clicked search result. Calculating a search engine performance metric value for each search session may be modifying a query during a user behavior in a search session.

The above-described search performance metric value for each search session may be a value obtained by calculating a search performance evaluation scale for each search session. A user behavior according to the present example embodiment may refer to an event requested by a user to execute on a search engine, and may include, for example, a click, next page, new query, refined query, and the like.

The log analyzer 200 may generate a search intent cluster by analyzing a case in which a user uses a similar query in a search session, and clustering search sessions in which the user requests similar information. Specifically, the log analyzer 200 may perform processes of extracting a query string for each search session, generating an embedding vector in a search session using a pre-trained bidirectional encoder representation from transformer (BERT) model, performing query embedding vector clustering, and extracting a representative word for each cluster using a term frequency-inverse document frequency (TF-IDF) score.

The log analyzer 200 may generate a behavior pattern cluster by clustering a session in which a user exhibits a similar behavior pattern in each search intent cluster. Specifically, the log analyzer 200 may perform n-gram extraction of a behavior in a search session, n-gram frequency-based session similarity calculation, similarity-based session clustering, and representative behavior pattern extraction for each cluster.

Referring to FIG. 2, the log analyzer 200 may be configured to provide a result of analyzing a search engine usage log through an input/output interface 300, and may output classification of search sessions generated by the log preprocessor 110, a result of clustering for each search intention and behavior pattern, and a search performance metric value for each search session through the input/output interface 300, such that a user may perform verification thereon. That is, the log analyzer 200 may support the user to retrieve, based on the output information, a search session presenting an unsatisfactory search result.

Specifically, the log analyzer 200 may include a search intention retriever 210, a behavior pattern retriever 230, a first search session retriever 250, and a second search session retriever 270.

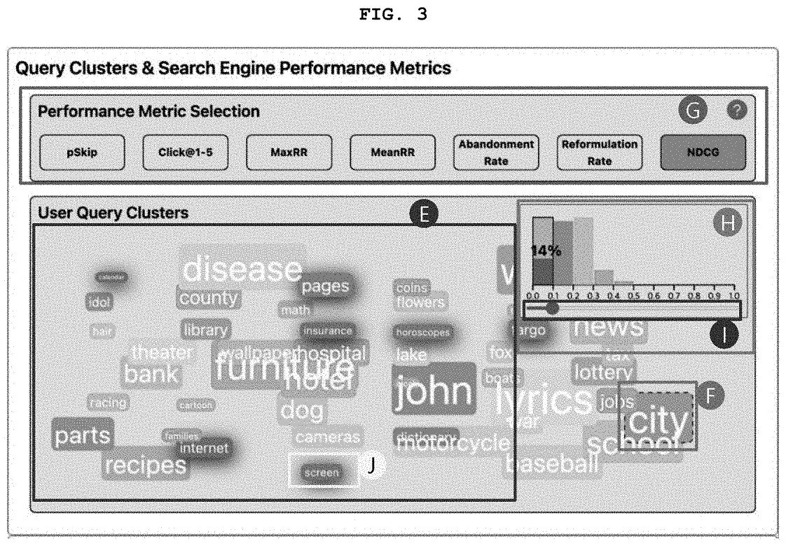

Referring to FIG. 3, the search intent retriever 210 may be configured to generate and output a similar search intention cluster using a search performance metric value for each search session and a result of session clustering for each search intent. The similar search intention cluster may refer to a cluster of search sessions having a similar search intent, and may be a bundle of keywords for each topic. In the present example embodiment, a topic may be replaced with a search intent or subject having the same meaning. That is, the search intent retriever 210 may visualize and present the similar search intention cluster to a user through the input/output interface 300, and may also provide a search engine performance metric value for each cluster, such that the user may select a problematic cluster in a search result.

The search intention retriever 210 may analyze a query input by the user in a search record so as to identify and analyze a search session having a similar search intention among large-scale user behavior records. The search intention retriever 210 may embed a meaning of the query input by the user in one search session into a vector space using a sentence embedding technique, and may cluster search sessions having a similar search intention using a clustering technique with respect to an embedding vector. In this case, various techniques including Word2Vec, BERT, and the like may be used for sentence embedding, and various techniques such as K-Means clustering and the like may be used during clustering.

When constructing an embedding vector including order information between search queries, the search intention retriever 210 may use a BERT model capable of forming an embedding vector, including order information between words. Specifically, the search intention retriever 210 may merge all queries in a search session into one string, and then may calculate a embedding vector of the string using a pre-trained BERT model to use the calculated embedding vector as an embedding vector of a search intention for each search session. The search intention retriever 210 may reduce a dimension of the embedding vector with a uniform manifold approximation and projection (UMAP) algorithm using a BERTopic library, and may generate a search intention cluster using an HDBSCAN algorithm.

The above-described search performance metric may include probability of skipping (pSkip), Click@1-5, MaxRR, MeanRR, Abandonment Rate, Reformulation Rate, and NDCG. The pSkip may refer to a probability of skipping a non-relevant document in order to provide an appropriate document to a user. For example, when a high-ranking document is selected from among search results by the user, pSkip may be close to 0. When a relatively low-ranking document is selected from among the search results by the user, pSkip may be calculated through Equation 1.

1−(number of documents selected from among search results/a rank of a lowest ranked document among the documents) [Equation 1]

For example, when two documents of rank 1 and rank 10 are selected by the user from among the search results, pSkip may be 1−(2/10)=0.8.

The Click@1-5 may refer to a ratio of queries selecting top five documents among all queries.

The MaxRR may refer to a maximum value among reciprocal ranks (RR). In this case, the RR may be calculated (1/rank) as a reciprocal number of a rank of a document selected among documents searched for each query in a search session, and the MeanRR (mean reciprocal rank) may refer to an average of RRs. For example, when second, fifth, and tenth documents are selected for a query in the search session,

$$MRR = ( \frac{1}{2} + \frac{1}{5} + \frac{1}{10} ) \div 3 , and Max RR = \frac{1}{2} .$$

The Abandonment Rate may refer to a ratio at which documents fora search query are not selected in a search session, and the NDCG (normalized discounted cumulative gain) may refer to normalizing an index to have a value between 0 and 1 regardless of a data set. The NDCG may be calculated through Equation 2.

$${NDCG}_{p} = \frac{{DCG}_{p}}{{max}_{∀ q} {DCG}_{q}} \qquad [ Equation 2 ]$$

The CG (cumulative gain) may be calculated by determining, as 0 and 1, whether or not top p search results are related to each other and summing up, and a highest level and a lowest level may be calculated at the same percentage without considering an order. The CG may be calculated through Equation 3.

$${CG}_{p} = {\sum }_{i = 1}^{p} {rel}_{i} \qquad [ Equation 3 ]$$

The DCG (discounted cumulative gain) may be treated with a higher percentage in a case of matching an upper level than a case of matching a lower level, and may be calculated through Equation 4.

$${DCG}_{p} = {\sum }_{i = 1}^{p} \frac{{rel}_{i}}{{log}_{2} ( i + 1 )} \qquad [ Equation 4 ]$$

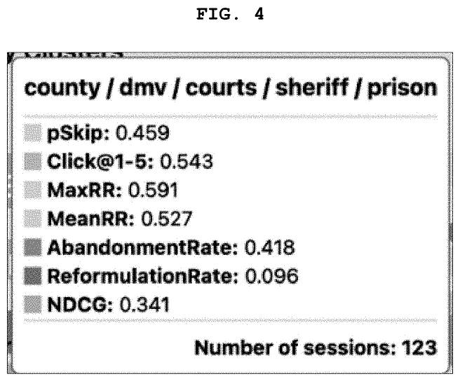

Referring to FIG. 4, the search intention retriever 210 may output a search performance metric value for each cluster, together with a similar search intention cluster.

When a similar search intention cluster is output, the search intention retriever 210 may output a representative query for each cluster in the form of a word cloud (E of FIG. 3). The word cloud may be an image indicating a frequency or importance of a specific word through a size of a letter, may be referred to setting a size of each cluster displayed on a dashboard to be proportional to the number of search sessions included in each cluster in the present example embodiment.

The search intention retriever 210 may add and output a distinguishing mark to an outlier cluster collecting a search session failing to classify a search intention (F of FIG. 3).

Referring to E of FIG. 3, when a similar search intention cluster is output, the search intention retriever 210 may output a size of a cluster in proportion to the number of search sessions included in each cluster. In this case, the location of each cluster may be randomly determined, and various designs may be applied based on a clustering feature such as similarity between search intentions for each cluster or a search engine metric value for each cluster according to the needs of an operator.

The search intention retriever 210 may calculate an average metric value for each cluster for a specific search performance metric (G of FIG. 3) selected by the user among a plurality of search performance metrics of the search engine, and may output, based on the calculation result, each cluster in a distinguishable color.

When a similar search intention cluster is output, the search intention retriever 210 may generate and output (H of FIG. 3) distribution of a search performance metric value for each cluster.

The search intention retriever 210 may change (I of FIG. 3) a distinguishing mark status for each cluster through adjustment of a threshold value that is a reference of distribution of the search performance metric value for each cluster. That is, the search intention retriever 210 may adjust to highlight a cluster having a value less than or equal to a specific metric value according to manipulation of the user. In this case, the search intention retriever 210 may output the highlighted cluster to be distinguished from other clusters through a visual effect such as a shadow, as illustrated in J of FIG. 3.

Referring to FIG. 4, the search intention retriever 210 may output another list of keywords associated with a cluster selected by a user and another search performance metric value of the cluster in a pop-up form.

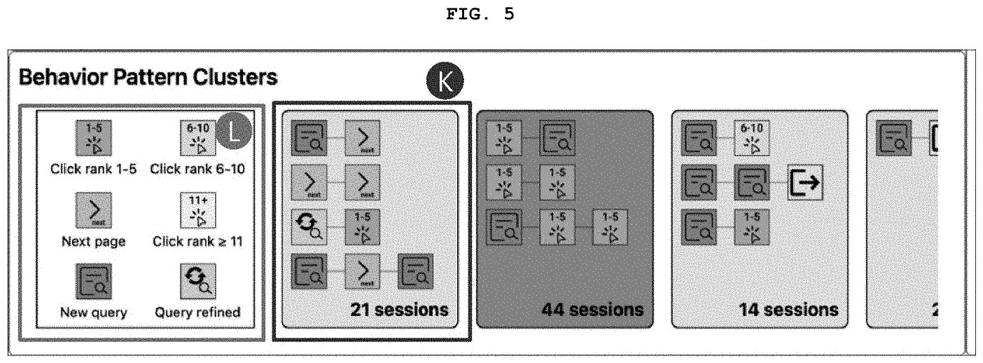

Referring to FIG. 5, the behavior pattern retriever 230 may be configured to generate and output a similar behavior pattern cluster and a behavior pattern for each cluster through clustering of a search session indicating a similar behavior pattern in a similar search intention cluster using a result of session clustering for each user behavior pattern.

The behavior pattern retriever 230 may generate and output a representative behavior pattern for each similar behavior pattern cluster (K of FIG. 5), and may classify and output (L of FIG. 5) a specific user behavior for each representative behavior pattern using a distinguishable icon and color. In this case, classification of the specific user behavior may be changed and applied in other manners according to the needs of an operator in addition to the icon and color. As the above-described specific user behavior is classified and output through the icon and color, it may be expected that a user is able to easily recognize a corresponding behavior pattern.

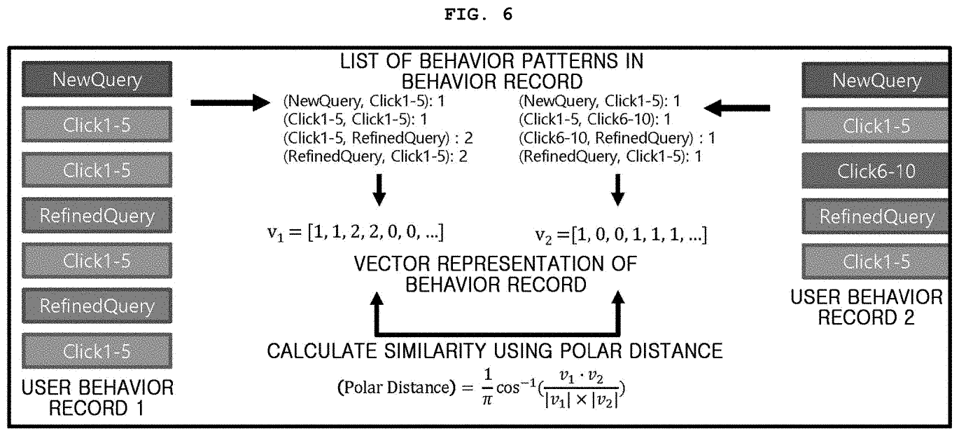

FIG. 6 is a diagram illustrating a process of calculating a similarity between behavior patterns between search user records. In order to generate a similar behavior pattern cluster, the behavior pattern retriever 230 may calculate a similarity between behavior records in user behavior records, and may cluster search sessions having a similar behavior pattern. In this case, a clickstream clustering technique for generating the similar behavior pattern cluster may be used.

Referring to FIG. 6, the behavior pattern retriever 230 may extract an n-gram of a behavior unit with respect to each user behavior record (user behavior records 1 and 2), and may generate a list of local behavior patterns (for example, including NewQuery, Click1-5, RefinedQuery, Click6-10, and the like) appearing in a behavior record, and then may express each behavior record in the form of a vector (for example, v₁=[1, 1, 2, 2, 0, 0, . . . ], v₂=[1, 1, 1, 1, . . . ]), using the number of appearances for each behavior pattern. In FIG. 6, a number described in the list of behavior patterns may refer to the number of appearances of a behavior pattern in a search session. In a similar manner of generating an n-gram in units of words from text, an n-gram of a user behavior may be generated using each user behavior (for example, Query, Click, or the like) as a word, and may be considered as a behavior pattern. In addition, in order to vectorize an individual search session of the user, the behavior pattern retriever 230 may first construct a set of all n-grams that are generatable in a user session in a log, and may assign a number to each n-gram. Thereafter, the behavior pattern retriever 230 may use a count of an n-th n-gram in the individual session as a value of an n-th dimension of the vectorized search session. Accordingly, the behavior pattern retriever 230 may set a vector value to 0 with respect to an n-gram not appearing in the search session.

A polar distance between the above-described two behavior record vectors may be calculated to calculate a behavior pattern similarity between the two behavior records. The behavior pattern similarity may be calculated through Equation 5.

$$( Polar Distance ) = \frac{1}{π} {cos}^{- 1} ( \frac{{v}_{1} \cdot {v}_{2}}{\vert {v}_{1} \vert \times \vert {v}_{2} \vert} \qquad [ Equation 5 ]$$

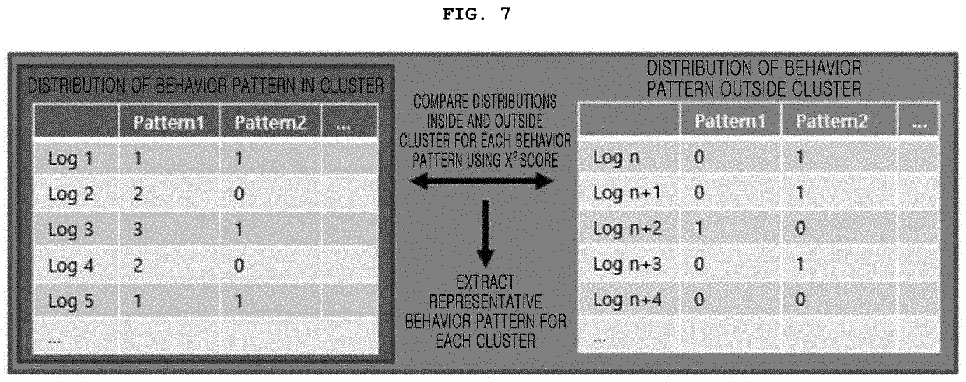

FIG. 7 is a diagram illustrating a process of extracting a representative behavior pattern for each behavior pattern cluster of a search engine user record.

The behavior pattern retriever 230 may construct a cluster of user behavior records by performing divisive hierarchical clustering between behavior records, using a similarity score between the user behavior records. The behavior pattern retriever 230 may compare appearance distributions inside and outside a cluster for each user behavior pattern with respect to the generated cluster, using a χ² score. Thus, the behavior pattern retriever 230 may select a behavior pattern characteristically and frequently appearing in the cluster, and may output the behavior pattern as a representative behavior pattern of each cluster, such that a user performs verification. In addition, when a cluster generated in a divisive hierarchical clustering process is additionally divided, the behavior pattern retriever 230 may exclude the pattern selected as the representative behavior pattern from a similarity calculation process to distinguish detailed clusters from each other.

For example, the cluster described with reference to FIG. may refer to a cluster of user search sessions. The behavior pattern retriever 230 may perform divisive hierarchical clustering using a polar distance for each session calculated in FIG. 6 with respect to an entire user search session set to divide a cluster into two portions such as an outside of the cluster excluded from the entire set and an inside of the cluster not excluded from the entire set. The behavior pattern retriever 230 may compare distribution of n-gram counts for each session with respect to the two divided clusters to find a behavior pattern significantly and frequently appearing in the excluded cluster.

The first search session retriever 250 may be configured to generate and output a user behavior for each search session.

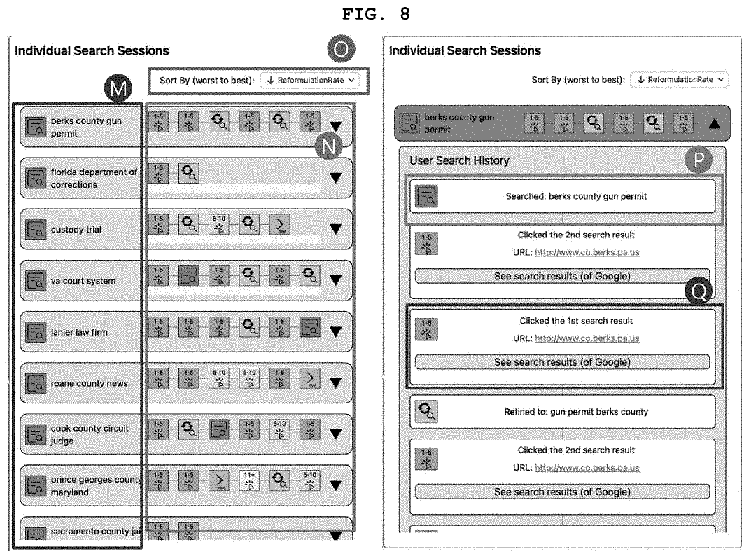

Referring to FIG. 8, when a specific similar behavior pattern cluster is selected by a user, the first search session retriever 250 may output a list M of search sessions included in the selected similar behavior pattern cluster, and may output (N) query information and a user behavior matched to each search session together. In this case, the first search session retriever 250 may provide first query information of a search session with respect to each search session, such that the user may perform verification thereon, and may easily identify a search intention of the search session.

When a list of search sessions is output, the first search session retriever 250 may adjust sorting of the list of search sessions according to a search performance metric value for each search session. To this end, as illustrated in O of FIG. 8, the first search session retriever 250 may output a menu for adjusting the sorting of the list of search sessions.

The second search session retriever 270 may be configured to generate and output a specific behavior of the user for a specific search session selected by the user.

Specifically, when the specific search session is selected by the user, the second search session retriever 270 may provide information on a specific behavior of the user in the search session to support understanding the behavior of the user in the search session. For example, when a query is input by the user, the second search session retriever 270 may provide query information input by the user (P of FIG. 8). Thereafter, when a click event for a search result is generated by the user, the second search session retriever 270 may provide (Q) an order of a search result clicked by the user (for example, an n-th search result) and a URL of a clicked webpage. Thus, the second search session retriever 270 may identify and provide a specific behavior of the user, such as information searched by a search engine user using a search engine, and a search result clicked in relation to a search intent of the user.

The above-described search engine performance evaluation apparatus 1000 may be implemented as a dashboard providing a user interface function for centrally managing and searching for various types of information on one screen on a web.

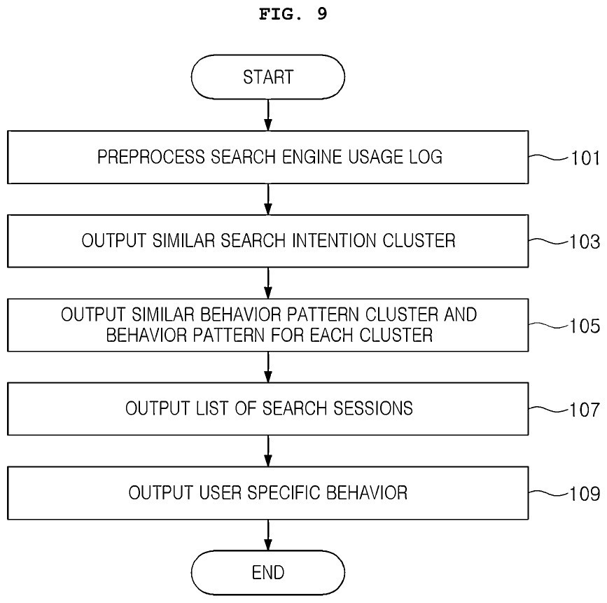

FIG. 9 is a flowchart illustrating a search engine performance evaluation method according to an example embodiment. The method illustrated in FIG. 9 may be performed by, for example, the search engine performance evaluation apparatus 1000 described above. In the illustrated flowchart, the method is described in a manner of dividing the method into a plurality of operations. However, at least some of the operations may be performed in a different order, may be performed in combination with other operations, may be omitted, may be divided into sub-operations, or may be performed with one or more operations not illustrated added thereto.

In operation 101, the search engine performance evaluation apparatus 1000 may preprocess a search engine usage log in a search engine usage log preprocessing pipeline manner.

In operation 103, the search engine performance evaluation apparatus 1000 may generate and output a similar search intention cluster using a search performance metric value for each search session and a result of session clustering for each search intent.

When the similar search intention cluster is output, the search engine performance evaluation apparatus 1000 may output a search performance metric value for each cluster together.

When the similar search intention cluster is output, the search engine performance evaluation apparatus 1000 may output a representative query for each cluster in the form of a word cloud.

When the similar search intention cluster is output, the search engine performance evaluation apparatus 1000 may add and output a distinguishing mark to an outlier cluster collecting a search session failing to classify a search intention.

The search engine performance evaluation apparatus 1000 may calculate an average metric value for each cluster for a specific search performance metric selected by the user among a plurality of search performance metrics of a search engine, and may output, based on a calculation result, each cluster in a distinguishable color.

The search engine performance evaluation apparatus 1000 may generate and output a distribution of search performance metric values for each cluster, but may change the classification display state for each cluster by adjusting a threshold value that is a criterion for the distribution of the search performance metric values for each cluster.

In operation 105, the search engine performance evaluation apparatus 1000 may generate and output a similar behavior pattern cluster and a behavior pattern for each cluster through clustering of a search session indicating a similar behavior pattern in the similar search intention cluster using a result of session clustering for each user behavior pattern. In this case, the search engine performance evaluation apparatus 1000 may classify and output a specific user behavior for each representative behavior pattern using a distinguishable icon and color.

In operation 107, the search engine performance evaluation apparatus 1000 may generate and output a behavior of a user for each search session. In this case, when a specific similar behavior pattern cluster is selected by the user, the search engine performance evaluation apparatus 1000 may output a list of search sessions included in the selected similar behavior pattern cluster, and may output query information and a user behavior matched to each search session together.

In operation 109, the search engine performance evaluation apparatus 1000 may generate and output a specific behavior of the user for a specific search session selected by the user.

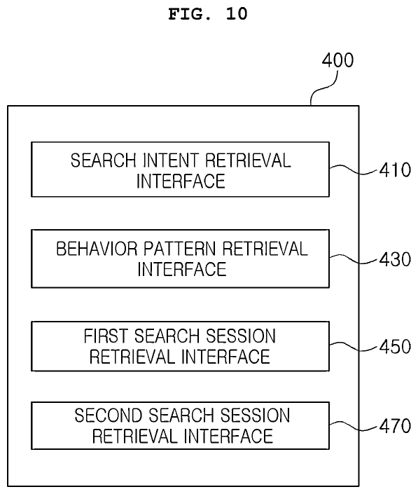

FIG. 10 is a block diagram illustrating a dashboard according to another example embodiment.

A dashboard 400 described below may perform a role the same as some of components of the search engine performance evaluation apparatus 1000 of FIG. 1 described above. Accordingly, a detailed description of an overlapping component will be omitted for ease of description.

Referring to FIG. 10, the dashboard 400 may include a search intent retrieval interface 410, a behavior pattern retrieval interface 430, a first search session retrieval interface 450, and a second search session retrieval interface 470.

The search intent retrieval interface 410 may be configured to output a similar search intention cluster using a search performance metric value for each search session and a result of session clustering for each search intent.

The behavior pattern retrieval interface 430 may be configured to output a similar behavior pattern cluster and a behavior pattern for each cluster through clustering of a search session indicating a similar behavior pattern in the similar search intention cluster using a result of session clustering for each user behavior pattern.

The first search session retrieval interface 450 may be configured to output a behavior of a user for each search session.

The second search session retrieval interface 470 may be configured to output a specific behavior of the user for a specific search session selected by the user.

The above-described search intent retrieval interface 410, behavior pattern retrieval interface 430, first search session retrieval interface 450, and second search session retrieval interface 470 may respectively perform roles the same as those of the search intention retriever 210, behavior pattern retriever 230, first search session retriever 250, and second search session retriever 270, and may also include a role of the input/output interface 300. To this end, although not illustrated, the dashboard 400 may further include a processor for controlling an entire operation in order to output information through each of the interfaces 410, 430, 450, and 470.

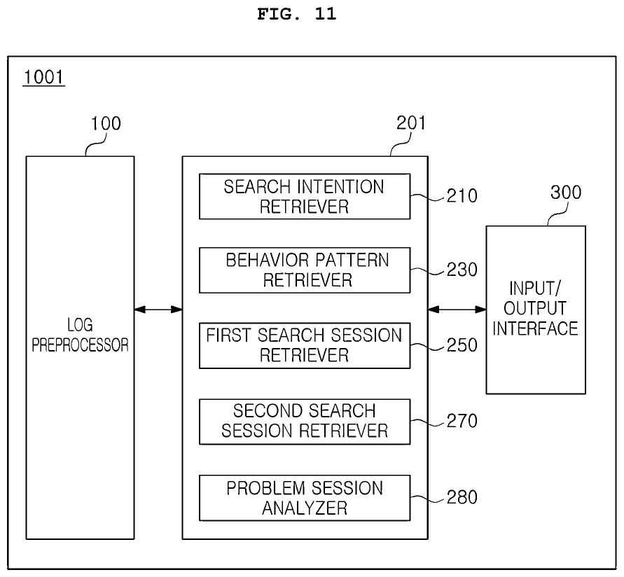

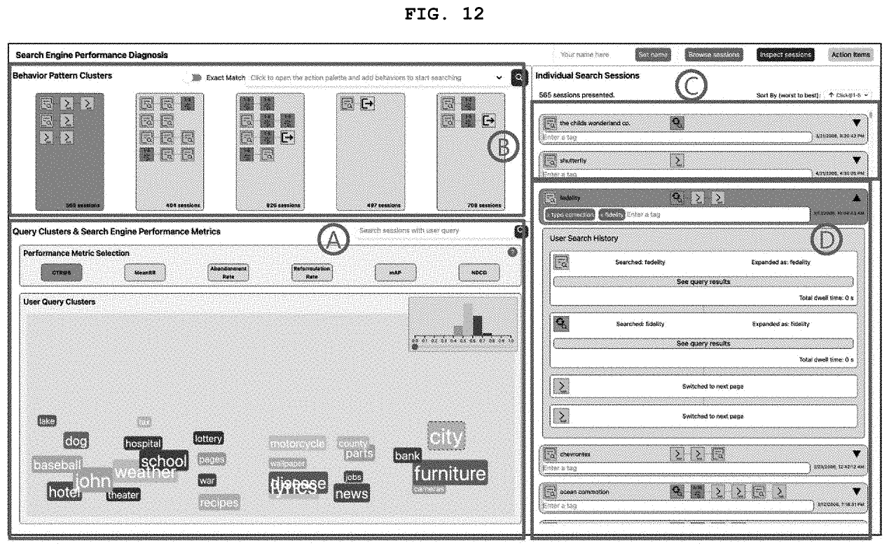

FIG. 11 is a block diagram illustrating an apparatus for evaluating search engine performance according to another example embodiment. Hereinafter, a description will be given with reference to FIGS. 12 to 19, exemplary diagrams illustrating a search engine performance evaluation method according to another example embodiment. A description overlapping the above-described search engine performance evaluation method will be omitted for simplicity and clarity of description.

Referring to FIG. 11, a search engine performance evaluation apparatus 1001 may include a log analyzer 201 and the input/output interface 300. In addition, the search engine performance evaluation apparatus 1001 may further include the log preprocessor 100.

Referring to FIG. 12, the log analyzer 201 may be configured to provide a result of analyzing a search engine usage log through the input/output interface 300.

Specifically, the log analyzer 201 may include the search intention retriever 210, the behavior pattern retriever 230, the first search session retriever 250, and the second search session retriever 270, and may further include a session analyzer 280.

The log analyzer 201 may output, through the input/output interface 300, classification of search sessions generated by the log preprocessor 100, and a clustering result for each search intention and behavior pattern, and a search performance metric value for each search session, such that a user may perform verification thereon. The input/output interface 300 may be configured differently according to settings. As illustrated in FIG. 2, the search performance metric value for each search session may be disposed on an upper portion of the log analyzer 201, and the clustering result for each search intention and behavior pattern may be disposed on a lower portion of the log analyzer 201, or vice versa as illustrated in FIG. 12.

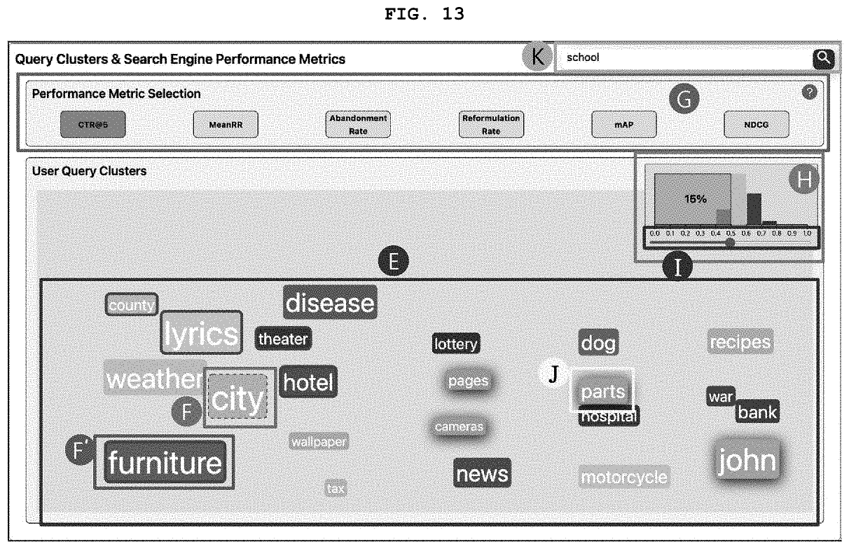

Referring to FIG. 13, the search intent retriever 210 may be configured to generate and output a similar search intention cluster using a search performance metric value for each search session and a result of session clustering for each search intent. That is, the search intent retriever 210 may visualize and present the similar search intention cluster to a user through the input/output interface 300, and may provide a search engine performance metric value for each cluster, thereby supporting the user to select a problematic cluster in a search result.

The above-described search performance metric may include Click-Through Rate (CTR)@5, MeanRR, Abandonment Rate, Reformulation Rate, mAP, and NDCG (G of FIG. 13).

The CTR@5 may refer to measuring a ratio of actual search results among the number of times a user inputs a query.

Referring to FIG. 13, the search intention retriever 210 may output a search performance metric value for each cluster, together with a similar search intention cluster.

When the similar search intention cluster is output, the search intention retriever 210 may output a representative query for each cluster in the form of a word cloud (E of FIG. 13). The word cloud may be an image indicating a frequency or importance of a specific word through a size of a letter, and may refer to setting a size of each cluster displayed on a dashboard to be proportional to the number of search sessions included in each cluster in the present example embodiment.

The search intent retriever 210 may search fora query for each similar search intention cluster through a search window (K of FIG. 13). Referring to E and K of FIG. 13, when “school” is input in the search window, a cluster in which a representative query is “school” or a cluster in which an expanded query is “school” may be searched in a word cloud, and a similar search intention cluster including the searched word may be output highlighted with a red line (F′ of FIG. 13). That is, the search intent retriever 210 may support a search function using a query such that a cluster in which a specific query input in the search window is used is easily found, and may support a visualization method for highlighting the cluster in which the specific query is used more than once.

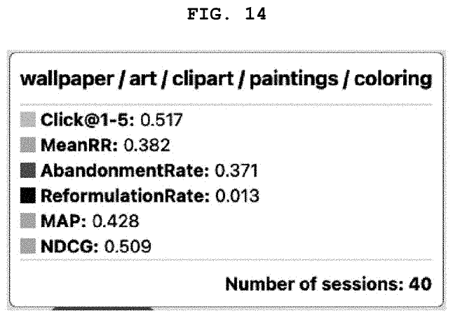

Referring to FIG. 14, the search intention retriever 210 may output another list of keywords associated with a cluster selected by a user and another search performance metric value of the cluster in a pop-up form.

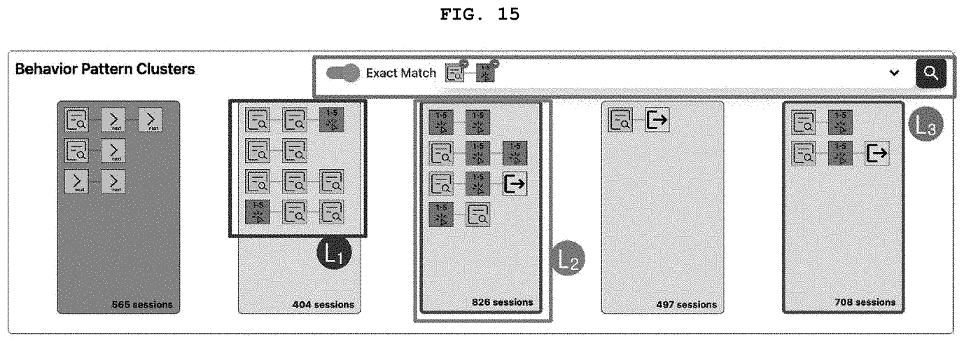

Referring to FIG. 15, the behavior pattern retriever 230 may be configured to generate and output a similar behavior pattern cluster and a behavior pattern for each cluster through clustering of a search session indicating a similar behavior pattern in a similar search intention cluster using a result of session clustering for each user behavior pattern.

The behavior pattern retriever 230 may generate and output a representative behavior pattern for each similar behavior pattern cluster (L₁ of FIG. 15), and may classify and output a specific user behavior for each representative behavior pattern using a distinguishable icon and color.

The behavior pattern retriever 230 may search for a representative behavior pattern for each cluster through a search window (L₃ of FIG. 15). A search function may be supported to assist a user in easily finding a search session including a specific behavior pattern of interest. As the searched similar behavior pattern is highlighted, a cluster including the similar behavior pattern may be searched.

Referring to FIG. 15, the behavior pattern retriever 230 may search for a cluster including a behavior pattern input through the search window. When the search is performed using Exact Match, a similar behavior pattern matching a behavior pattern input for the search and an order of the behavior pattern may be searched to highlight a cluster including a session having the similar behavior pattern with a red line (L₂ of FIG. 15). The Exact Match function may be provided as ON/OFF.

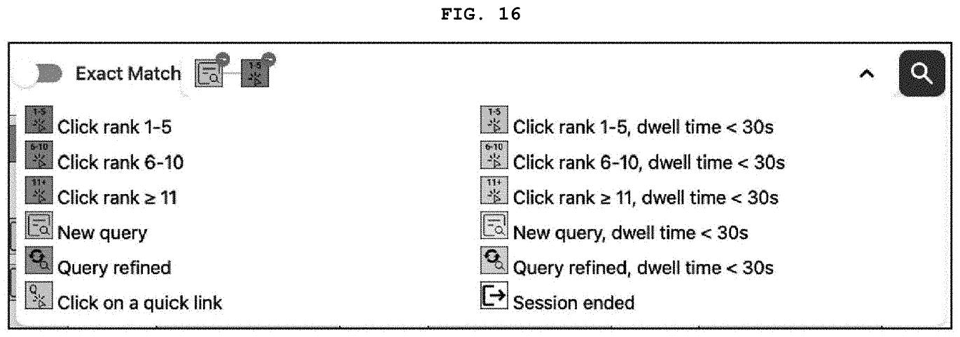

Referring to FIG. 16, the behavior pattern retriever 230 may specify a behavior pattern using an icon list listing a specific user behavior for each representative behavior pattern. The specific user behavior may be input into a search window by clicking on the icon list.

In this case, an icon and a color may be determined according to a behavior of a user. When an additional dwell time is applied to the behavior of the user, the color may be changed and output to the same icon.

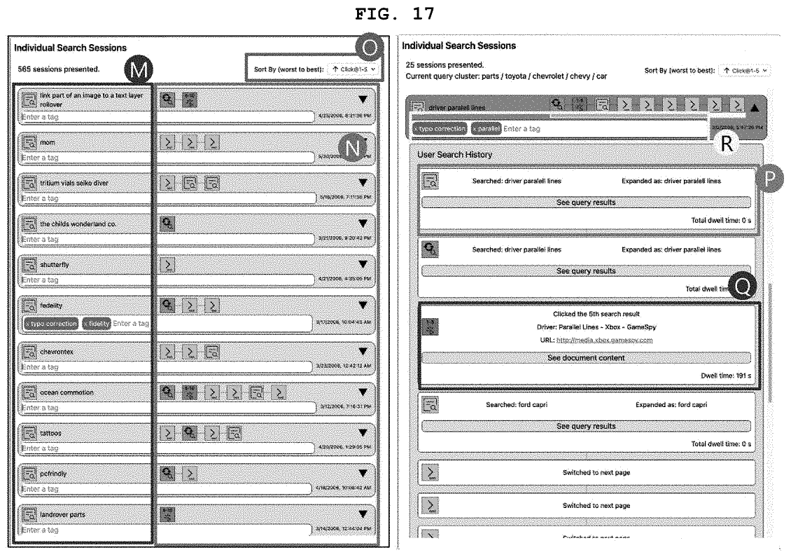

Referring to FIG. 17, when a specific similar behavior pattern cluster is selected by a user, the first search session retriever 250 may output a list M of search sessions included in the selected similar behavior pattern cluster, and may output (N) query information and a user behavior matched to each search session together. In this case, the first search session retriever 250 may provide first query information of a search session with respect to each search session, such that the user may perform verification thereon, and may easily identify a search intention of the search session.

The first search session retriever 250 may tag a tag for each search session by the user. The tag may be input in natural language to indicate a problem session not satisfying a search user, and may be used for the problem session analyzer 280 to be described below to analyze each session having the same problem.

When a list of search sessions is output, the first search session retriever 250 may adjust sorting of the list of search sessions according to a search performance metric value for each search session (O of FIG. 17).

The second search session retriever 270 may be configured to generate and output a specific behavior of the user for a specific search session selected by the user.

Specifically, when the specific search session is selected by the user, the second search session retriever 270 may provide information on the specific behavior of the user in the search session to support understanding of the behavior of the user in the search session. For example, when a query is input by the user, the second search session retriever 270 may provide query information input by the user (P of FIG. 17).

Thereafter, when a click event for a search result is generated by the user, the second search session retriever 270 may provide (Q) an order of a search result clicked by the user (for example, an n-th search result) and a URL of a clicked webpage. Thus, the second search session retriever 270 may identify and provide a specific behavior of the user, such as information searched by a search engine user using a search engine, and a search result clicked in relation to a search intent of the user.

Referring to FIG. 17, the second search session retriever 270 may tag a tag for each search session by the user. The tag may be input in natural language to indicate a problem session not satisfying a search user, and may be used for the problem session analyzer 280 to be described below to analyze each session having the same problem. When it is determined that the search result does not satisfy the user by verifying the specific behavior of the user, the second search session retriever 270 may support problem analysis by tagging a corresponding search session. As illustrated in R of FIG. 17, when typo correction and parallel tags are input with respect to a driver parallel lines search session, the problem session analyzer 280 to be described below may analyze, at once, fedelity and driver parallel lines search sessions tagging a typo correction tag when typo correction is searched.

That is, problems existing with respect to a search pattern for each session may be tagged by the user, and the tagged problems may be collected, thereby comprehensively performing search and analysis.

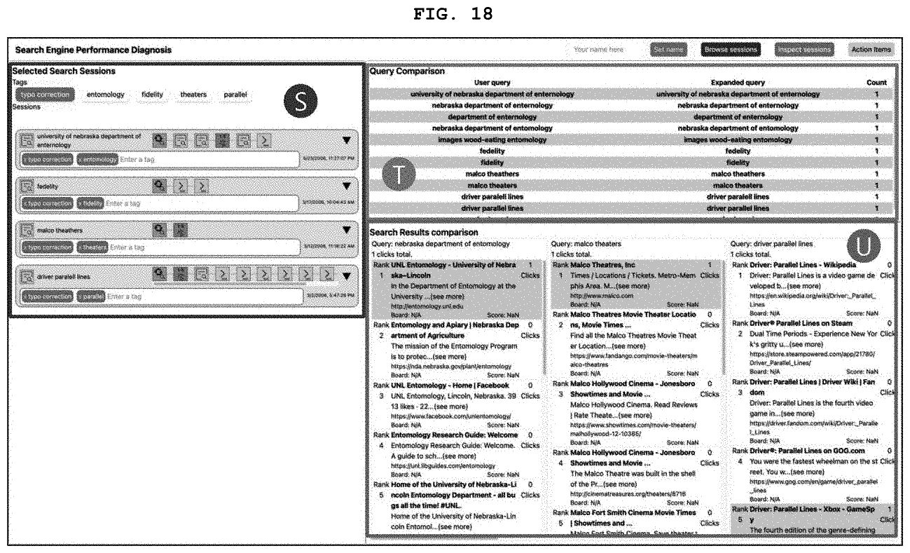

Referring to FIG. 18, when a specific search session is selected by a user, the problem session analyzer 280 may classify or sort the search session according to a tag to support additional analysis with respect to problems in the search session.

Referring to FIG. 18, search sessions tagged with a tag and tags tagged to the search sessions may be visualized and output (S of FIG. 18). When at least one tag is clicked, search sessions tagged with the at least one tag may be preferentially sorted or only the search sessions tagged with the tag may be sorted. Search sessions not tagged with the at least one tag may not be visualized and output, or may be sorted in a lower-priority order.

In this case, the tag may include information on a search session unsatisfied by a search user to support additional analysis for resolving a problem of the search session.

The problem session analyzer 280 may sort an input query input by the user and an expanded query obtained by expanding the input query and perform a query comparison between the input query and the expanded query (T of FIG. 18). That is, a query comparer comparing how a search engine expands the input query may be generated and output, thereby checking a query expansion algorithm of the search engine.

In addition, the number of times the user searches for query information including the input query and the expanded query may be provided as a count (T of FIG. 18).

The problem session analyzer 280 may provide search results of the query information, and may provide a search result actually selected by the user from among the search results of the query information (U of FIG. 18). A search result comparer, listing the search results of the query information, and highlighting the search result actually selected by the user by changing a color or showing the number of times the user actually clicks together, may be generated and output. Thus, a ranking algorithm of the search engine may be checked by comparing ranking of search results provided by the search engine with ranking of results selected by the actual user. In this case, the search result of the query information may be verified by clicking an internal document as a search result for the input query and the expanded query.

The problem session analyzer 280 may use a tag tagged to a search session unsatisfied by a search engine user to provide additional analysis for search sessions with the same tag, and identify a problem of the search engine according to an analysis result and derive a direction of improvement.

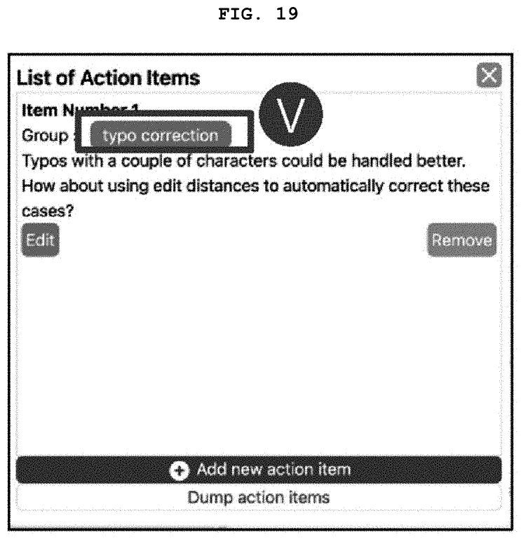

Referring to FIG. 19, the problem session analyzer 280 may provide generation and disposal of a correction solution for correcting a problem in the search engine. With respect to search sessions tagged with the same tag, a correction solution for resolving the tagged problem may be collectively added (V of FIG. 19). That is, a correction solution for improving the search engine may be prepared with respect to the search engine problem, and the correction solution may be connected to tags of search sessions to be used as a basis for future search engine improvement.

The above-described search engine performance evaluation apparatus 1001 may be implemented as a dashboard providing a user interface function for centrally managing and searching for various types of information on one screen on a web.

The search engine performance evaluation apparatus 1001 may provide a direction of improvement for improving search engine performance by analyzing an actual search result selected by a user with respect to an input query and an expanded query, after output of a user specific behavior is completed.

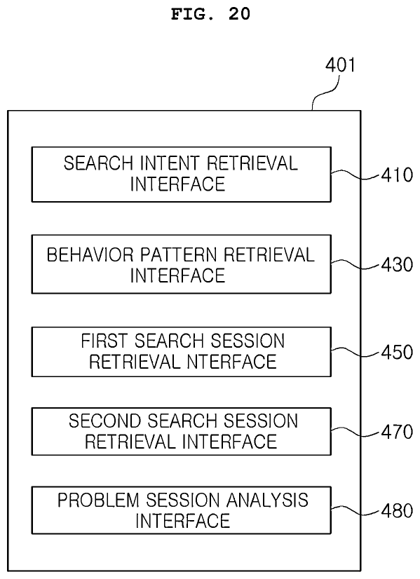

FIG. 20 is a block diagram illustrating a dashboard according to another example embodiment.

A dashboard 401 described below may perform a role the same as some of the components of the search engine performance evaluation apparatus 1001 of FIG. 11 described above. Accordingly, a detailed description of an overlapping component will be omitted for ease of description.

Referring to FIG. 20, the dashboard 401 may include the search intent retrieval interface 410, the behavior pattern retrieval interface 430, the first search session retrieval interface 450, the second search session retrieval interface 470, and the problem session analysis interface 480.

The problem session analysis interface 480 may be configured to compare and output a query provided by a search engine with an actual selection result of a user for a specific search session selected by the user.

The above-described search intent retrieval interface 410, behavior pattern retrieval interface 430, first search session retrieval interface 450, second search session retrieval interface 470, and problem session analysis interface 480 may respectively perform roles the same as those of the search intention retriever 210, the behavior pattern retriever 230, the first search session retriever 250, the second search session retriever 270, and the problem session analyzer 280, and may also include a role of the input/output interface 300. To this end, although not illustrated, the dashboard 401 may further include a processor for controlling an entire operation in order to output information through each of the interfaces 410, 430, 450, 470, and 480.

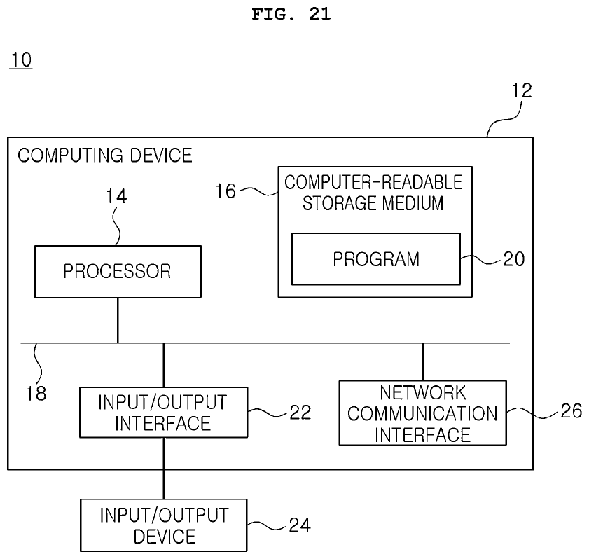

FIG. 21 is a block diagram illustrating a computing environment including a computing device according to an example embodiment. In the illustrated example embodiment, respective components may have different functions and capabilities in addition to those described below, and may include additional components in addition to those described below.

The illustrated computing environment 10 may include a computing device 12. In an example embodiment, the computing device 12 may be the search engine performance evaluation apparatuses 1000 and 1001. In addition, the computing device 12 may be the dashboards 400 and 401.

The computing device 12 may include at least one processor 14, a computer-readable storage medium 16, and a communication bus 18. The processor 14 may cause the computing device 12 to operate according to the example embodiments described above. For example, the processor 14 may execute one or more programs stored on the computer-readable storage medium 16. The one or more programs may include one or more computer-executable instructions, which, when executed by the processor 14, may be configured to cause the computing device 12 to perform operations according to example embodiments.

The computer-readable storage medium 16 may be configured to store the computer-executable instruction or program code, program data, and/or other suitable forms of information. A program 20 stored in the computer-readable storage medium 16 may include a set of instructions executable by the processor 14.

In an example embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and are capable of storing desired information, or any suitable combination thereof.

The communication bus 18 may interconnect various other components of the computing device 12, including the processor 14 and the computer-readable storage medium 16.

The computing device 12 may also include one or more input/output interfaces 22 providing an interface for one or more input/output devices 24, and one or more network communication interfaces 26. The input/output interface 22 and the network communication interface 26 may be connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touchpad or touchscreen), a voice or sound input device, input devices such as various types of sensor devices and/or photographing devices, and/or output devices such as a display device, a printer, a speaker, and/or a network card. The exemplary input/output device 24 may be included in the computing device 12 as a component included in the computing device 12, or may be connected to the computing device 12 as a device distinct from the computing device 12.

The above-described present example embodiments may present a pipeline for defining similarity between search sessions by encompassing multilayered user data in a search engine usage record. For example, in the present example embodiment, when a query is input by a user in a search session, a case in which desired information is not searched using a previous input query and the query is modified may be distinguished from a case in which desired information is not searched using a previous input query and a new query is input regardless of the previous query. Specifically, this is because a user behavior in the search session is subdivided according to an intention of the user, and similarity information of the search session is applied in units of user behaviors based on similarity between subdivided search behaviors in the present example embodiment. For example, a user who search for “vacation” may be more likely to use a search engine with an intention similar to that of a user who searches for a similar word such as “sick leave,” “annual leave,” or the like. In the present example embodiment, on the basis of such a principle, search intention similarity information of the user may be used based on similarity between queries input by the user.

In addition, in the present example embodiments, an interaction element for using the expertise of a search engine developer and administrator may be provided to find a search session not satisfying a search intent of a search engine user in a large-scale search session record. For example, the search engine administrator may accumulate information on the characteristics of the search engine user, a main search purpose, a characteristic search behavior pattern, and the like through experience. In order to allow the search engine administrator to retrieve a search engine usage history using such expertise, an interaction clustering and visualizing a session based on search intent similarity and search behavior pattern similarity between search sessions, the interaction usable for session retrieval may be provided. In addition, a user behavior in an individual session may be visualized in the form of an icon to summarize and present a user behavior in a search session, and to efficiently present information such as a query content of the user and a clicked URL with respect to an individual user behavior, thereby using the expertise of the search engine administrator.

While example embodiments have been shown and described above, it will be apparent to those skilled in the art that modifications and variations could be made without departing from the scope of the present disclosure as defined by the appended claims.

What is claimed is:

1. An apparatus for evaluating search engine performance, the apparatus comprising:
one or more processors; and
a memory storing one or more programs configured to be executed by the one or more processors, wherein the one or more processors are configured to implement:
a search intent retriever configured to generate and output a similar search intention cluster using a search performance metric value for each search session and a result of session clustering for each search intention;
a behavior pattern retriever configured to generate and output a similar behavior pattern cluster and a behavior pattern for each cluster through clustering of a search session indicating a similar behavior pattern in the similar search intention cluster by using a result of session clustering for each user behavior pattern;
a first search session retriever configured to generate and output a behavior of a user for each search session; and
a second search session retriever configured to generate and output a specific behavior of the user for a specific search session selected by the user.

2. The apparatus of claim 1, wherein the search intention retriever is configured to output a search performance metric value for each cluster, together with the similar search intention cluster.

3. The apparatus of claim 1, wherein, when the similar search intention cluster is output, the search intent retriever is configured to output a representative query for each cluster in the form of a word cloud.

4. The apparatus of claim 1, wherein the search intention retriever is configured to output a an outlier cluster to which a distinguishing mark is added, and the outlier cluster is a cluster collecting a search session failing to classify a search intention.

5. The apparatus of claim 1, wherein, when the similar search intention cluster is output, the search intention retriever is configured to output a size of the similar search intention cluster in proportion to the number of search sessions included in each cluster.

6. The apparatus of claim 1, wherein the search intention retriever is configured to calculate an average metric value for each cluster for a specific search performance metric selected by the user among a plurality of search performance metrics of a search engine, and to output, based on the calculated average metric value, each cluster in a distinguishable color.

7. The apparatus of claim 1, wherein, when the similar search intention cluster is output, the search intention retriever is configured to generate and output distribution of a search performance metric value for each cluster.

8. The apparatus of claim 7, wherein the search intention retriever is configured to change a distinguishing mark status for each cluster through adjustment of a threshold value that is a reference of the distribution of the search performance metric value for each cluster.

9. The apparatus of claim 1, wherein the similar search intention cluster is a bundle of keywords for each topic, and the search intention retriever is configured to output another list of keywords associated with a cluster selected by the user and another search performance metric value of the cluster in a pop-up form.

10. The apparatus of claim 1, wherein the behavior pattern retriever is configured to generate and output a representative behavior pattern for each similar behavior pattern cluster, and to classify and output a specific user behavior for each representative behavior pattern using a distinguishable icon and color.

11. The apparatus of claim 1, wherein, when a specific similar behavior pattern cluster is selected by the user, the first search session retriever is configured to output a list of search sessions included in the selected similar behavior pattern cluster, and to output query information and a user behavior matched to each search session.

12. The apparatus of claim 11, wherein, when the list of search sessions is output, the first search session retriever is configured to adjust sorting of the list of search sessions according to the search performance metric value for each search session.

13. The apparatus of claim 1, wherein at least one of the first search session retriever and the second search session retriever is configured to output a tag tagged to the specific search session selected by the user; and
the apparatus further includes a problem session analyzer configured to generate and output a correction solution connected to the tag, using the tag of the specific search session.

14. The apparatus of claim 13, wherein the problem session analyzer is configured to:
generate and output a query comparer configured to compare an input query for each search session and an expanded query for the input query; and/or
generate and output a search result comparer configured to compare a search result for each search session and a specific behavior of the user for the search result.

15. The apparatus of claim 1, wherein the search intent retriever is configured to output a search window for searching for a specific query in the similar search intention cluster;
the behavior pattern retriever is configured to output a search window for searching for a specific behavior pattern in the similar behavior pattern cluster; or
the first search session retriever is configured to output an input window for tagging a tag for each search session to the first search session retriever or the second search session retriever.

16. The apparatus of claim 15, wherein the behavior pattern retriever is configured to output a search window for searching for a specific behavior pattern in the similar behavior pattern cluster; and
the search window for searching for the specific behavior pattern in the similar behavior pattern cluster is configured to output a result including an input specific behavior pattern or to output a result the same as a sequence of the input specific behavior pattern.

17. A method for evaluating search engine performance, the method performed on a computing device including one or more processors and a memory storing one or more programs executed by the one or more processors, the method comprising:
generating and outputting a similar search intention cluster using a search performance metric value for each search session and a result of session clustering for each search intention;
generating and outputting a similar behavior pattern cluster and a behavior pattern for each cluster through clustering of a search session indicating a similar behavior pattern in the similar search intention cluster by using a result of session clustering for each user behavior pattern;
generating and outputting a behavior of a user for each search session; and
generating and outputting a specific behavior of the user for a specific search session selected by the user.

18. The method of claim 17, wherein the generating and outputting of the similar search intention cluster includes outputting a search performance metric value for each cluster, together with the similar search intention cluster.

19. The method of claim 17, wherein the generating and outputting of the similar search intention cluster includes outputting a representative query for each cluster in the form of a word cloud.

20. The method of claim 17, wherein the generating and outputting of the similar search intention cluster includes outputting an outlier cluster to which a distinguishing mark is added, and the outlier cluster is a cluster collecting a search session failing to classify a search intention.

21. The method of claim 17, wherein the generating and outputting the similar search intention cluster includes calculating an average metric value for each cluster for a specific search performance metric selected by the user among a plurality of search performance metrics of a search engine, and outputting, based on the calculated average metric value, each cluster in a distinguishable color.

22. The method of claim 17, wherein the generating and outputting the similar search intention cluster includes generating and outputting distribution of a search performance metric value for each cluster, and changing a distinguishing mark status for each cluster through adjustment of a threshold value that is a reference of the distribution of the search performance metric value for each cluster.

23. The method of claim 17, wherein the generating and outputting of the similar behavior pattern cluster and the behavior pattern for each cluster includes classifying and outputting a specific user behavior for each representative behavior pattern using a distinguishable icon and color.

24. The method of claim 17, wherein the generating and outputting the behavior of the user for each search session includes outputting a list of search sessions included in the selected similar behavior pattern cluster, when a specific similar behavior pattern cluster is selected by the user, and outputting query information and a user behavior matched to each search session.

25. The method of claim 17, wherein the generating and outputting of the behavior of the user for each search session includes outputting a list of search sessions included in the selected similar behavior pattern cluster, when a specific similar behavior pattern cluster is selected by the user, and outputting a tag tagged to each search session; and
the method further includes generating and outputting a correction solution connected to the tag using the tag of the search session.

26. The method of claim 25, further comprising:
generating and outputting a query comparer configured to compare an input query for each search session and an expanded query for the input query; and/or
generating and outputting a search result comparer configured to compare a search result for each search session and a specific behavior of the user for the search result.

27. The method of claim 17, wherein the generating and outputting of the similar search intention cluster includes outputting a search window for searching for a specific query in a similar search intention cluster;
the generating and outputting of the similar behavior pattern cluster and the behavior pattern for each cluster includes outputting a search window for searching for a specific behavior pattern in the similar behavior pattern cluster; or
the generating and outputting of the behavior of the user for each search session or the generating and outputting of the specific behavior of the user for the specific search session selected by the user includes outputting an input window for tagging a tag for each search session.

28. The method of claim 27, wherein the generating and outputting of the similar behavior pattern cluster and the behavior pattern for each cluster includes outputting a search window for searching for a specific behavior pattern in the similar behavior pattern cluster; and
the search window for searching for the specific behavior pattern in the similar behavior pattern cluster is configured to output a result including an input specific behavior pattern or to output a result the same as a sequence of the input specific behavior pattern.

29. A dashboard comprising:
a search intent retrieval interface configured to output a similar search intention cluster using a search performance metric value for each search session and a result of session clustering for each search intent;
a behavior pattern retrieval interface configured to output a similar behavior pattern cluster and a behavior pattern for each cluster through clustering of a search session indicating a similar behavior pattern in the similar search intention cluster using a result of session clustering for each user behavior pattern;
a first search session retrieval interface configured to output a behavior of a user for each search session; and
a second search session retrieval interface configured to output a specific behavior of the user for a specific search session selected by the user.
